(19) United States
(12) Patent Application Publication
(10) Pub. No.: US 2006/0161349 A1
(43) Pub. Date: Jul. 20, 2006

(54) GPS device and method for displaying raster images

(76) Inventors: John Cross, Overland Park, KS (US); Christopher Lalik, Overland Park, KS (US); John DeCastro, Lenexa, KS (US); Richard Ball, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/037,735

(22) Filed: Jan. 18, 2005

(51) Int. Cl. G01S 1/00

(52) U.S. Cl. 701/213; 342/357.06

(57) ABSTRACT

A GPS device adapted and operable to download and store, receive, or otherwise obtain and display any of a variety of different types of geo-referenced raster images, such as, for example, aerial photographs, and to integrate those images into a scheme of information which is relevant to navigation and travel generally.

### BACKGROUND OF THE INVENTION

1. Field of the Invention

The present invention relates broadly to hand-held electronic GPS-based navigation aids and related methods for facilitating navigation. More particularly, the present invention concerns a GPS device and method for displaying any of a variety of different types of geo-referenced raster images, such as, for example, aerial photographs, and for fully integrating said images into a scheme for providing information which is relevant to navigation and travel generally.

2. Description of the Prior Art

Outdoor enthusiasts, such as sportsmen, vacationers, and athletes, have long used a variety of different means to safely navigate while afield. Traditionally, these means comprised compasses, topographical maps, and aerial photographs. Because these enthusiasts often travel on foot or in or on light vehicles, the space requirements for and weight of all such items are important considerations that limit the number and variety of maps and photographs that can be carried into the field. Furthermore, unprotected paper maps and photographs are notorious difficult to maintain, particularly under adverse weather conditions.

In light of these and other problems and limitations with the aforementioned traditional means, an increasing number of enthusiasts now use global positioning system (GPS) devices to navigate while in the field. Commonly-available GPS devices typically include at least a processor, a receiver, and an antenna for receiving position signals from a plurality of known locations (e.g., from orbiting satellites) and, through a process of geometric triangulation, determining the relative location of the GPS device in terms of latitude, longitude, and even altitude. Many such devices also allow users to, for -example, create waypoints; create and follow tracks; and view street maps and topographical maps. Because these GPS devices are meant to be used in the field, they are appropriately designed and constructed so as to be lightweight, rugged, waterproof, and otherwise resistant to relatively harsh environments and operating conditions.

Unfortunately, no stand-alone GPS device allows for displaying aerial photographs or other geo-referenced raster images. It is possible to download and display such images on computers and personal digital assistants that are coupled or otherwise provided with a GPS module, but these combination devices are too large, heavy, expensive, or fragile for use in the field, particularly under adverse weather conditions. In fact, the use of computers and PDAs raises many of the same problems and limitations as the aforementioned paper maps and photographs. While some brands of computers and PDAs offer supplemental enclosures for outdoor use, these enclosures significantly increase the already substantial size, weight, and expense of those devices. Furthermore, the connection between the computer or PDA and the GPS module requires a USB, Bluetooth, or other connection which further adds to the ungainliness, fragility, and general undesirability of this solution

Due to these and other disadvantages in the prior art, a need exists for a GPS device capable of displaying geo-referenced raster images so as to better enable safe and efficient navigation while in the field.

### SUMMARY OF THE INVENTION

The present invention overcomes the above-described and other disadvantages in the prior art by providing a GPS device and method for downloading and storing, receiving, or otherwise obtaining and displaying any of a variety of different types of geo-referenced raster images, and for fully integrating said images into a scheme of information which is relevant to navigation and travel generally.

The raster images may be any one or more or a combination of different forms or types of photographs or other images conveying different types of information, such as, for example, aerial photographs; perspective photographs; topographical maps; satellite images; weather images; and Doppler radar images. Each such raster image is geo-referenced by associating geographic coordinates with each pixel of the raster image so that the raster image can be properly oriented at the time of display and so that the user can select any pixel within the raster image and conveniently view the corresponding coordinates. Also, waypoints; trails; symbols or other indicators corresponding to natural or artificial structures; and other geo-referenced information may be laid over, integrated into, or otherwise associated with displayed raster image.

The present invention also allows for toggling between different images while the aforementioned geo-referenced information remains continuously displayed so that the user can easily and quickly view or otherwise investigate prior paths, future paths, waypoints, and other geo-referenced information from a variety of different perspectives without experiencing disorientation.

The GPS device may include any or all of various obtainment mechanisms, such as an input port, a transceiver, and/or a plurality of exchangeable memory devices, for obtaining desired raster images for display. The input port allows for prior downloading and storing of the raster images from a remote source via a network. The transceiver allows for prior or current downloading and storing of the desired images via a wireless network prior to entering or while in the field. The exchangeable memory devices allow for selecting and carrying a larger number of raster images than would otherwise be possible using only the GPS device's limited onboard memory. More specifically, a large number of raster images can be downloaded and stored on a plurality of the exchangeable memory devices prior to entering the field, and, when a particular stored raster image is desired, the particular memory device on which it is stored can be inserted into the GPS device.

Thus, it will be appreciated that the GPS device and method of the present invention provides a number of substantial advantages over the prior art, including, for example, allowing for displaying any of a variety of different types of geo-referenced raster images on a small, lightweight, and rugged GPS device, and for integrating said images into a scheme of information which is relevant to navigation and travel generally.

Furthermore, the present invention advantageously allows for displaying geo-referenced information over or otherwise in association with a displayed raster image, and for continuously displaying said information while toggling between maps, photographs, to other images or views, thereby eliminating disorientation and more fully and usefully integrating the raster image into the information scheme.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a block-diagram depiction of a preferred embodiment of a GPS device and system of the present invention;

FIG. 2 is a depiction of a first geo-referenced aerial photograph overlayed with a waypoint and a trail, wherein the geo-referenced aerial photograph is displayed on a display component of the GPS device of FIG. 1;

FIG. 3 is a depiction of geo-referenced street map overlayed with the waypoint and the trail of FIG. 2, wherein the geo-referenced street map is displayed on the display component of the GPS device of FIG. 1, and wherein a user of the GPS device can toggle between the aerial photograph of FIG. 2 and the street map of FIG. 3 while the overlayed waypoint and trail are continuously displayed;

FIG. 4 is a depiction of a second geo-referenced aerial photograph overlayed with a waypoint and a trail, wherein the geo-referenced aerial photograph is displayed on a display component of the GPS device of FIG. 1; and

FIG. 5 is a flowchart of steps involved in operation of the GPS device of FIG. 1.

### DETAILED DESCRIPTION OF THE PREFERRED EMBODIMENT(S)

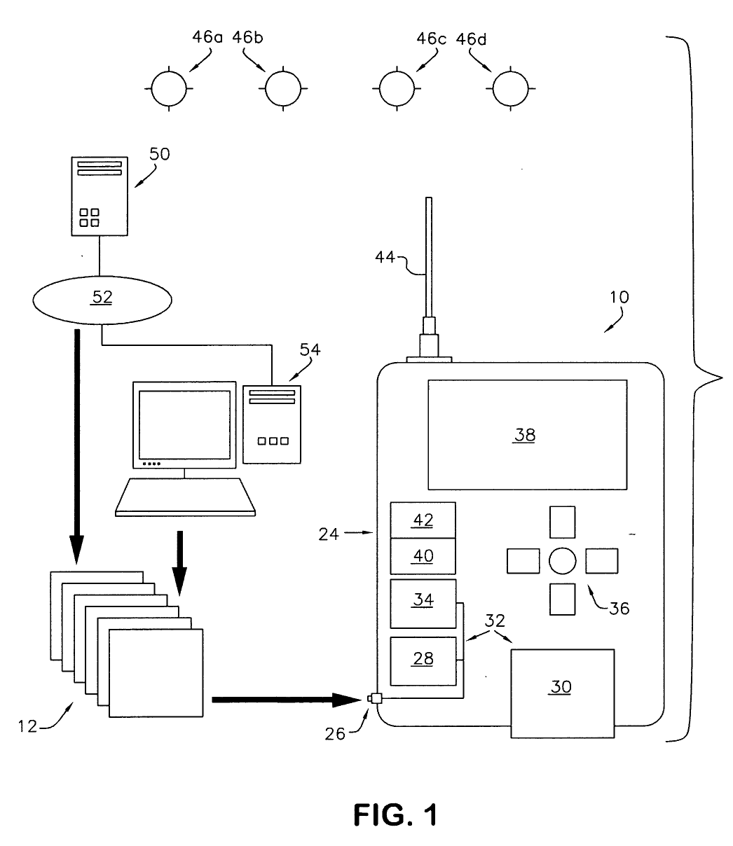

With reference to the figures, a GPS device 10 and method are herein described, shown, and otherwise disclosed in accordance with the preferred embodiment(s) of the present invention. More specifically, referring to FIG. 1, the present invention allows a user of the GPS device 10 to download and store, receive, or otherwise obtain and display any of a variety of different types of geo-referenced raster images 12 and to fully integrate said images into a scheme of information which is relevant to navigation and travel generally.

The raster images 12 may be any one or more or a combination of different forms or types of photographs or other images conveying different types of information, such as, for example, aerial photographs; perspective photographs; topographical maps; satellite images; weather images; and Doppler radar images. Furthermore, the raster images may have been created using any one or more or a combination of different techniques or formats, such as, for example, capturing emissions or reflections of radio, visual, infrared, ultraviolet, or other electromagnetic radiation; capturing emissions or reflections of thermal radiation; and capturing emissions or reflections of sound waves.

The raster images 12 are appropriately conditioned or otherwise processed for use either prior to download, after download and prior to display, or immediately prior to display. Each raster image 12 is, for example, geo-referenced by associating geographic coordinates with each pixel of the raster image so that the raster image can be properly oriented at the time of display and so that the user can select any pixel within the raster image and conveniently view the corresponding coordinates.

Also, the present invention allows for overlaying, integrating, or otherwise associating waypoints; trails; symbols or other indicators corresponding to natural or artificial structures; and other geo-referenced information over, into, or with the displayed raster image, thereby further integrating the raster image into the aforementioned information scheme.

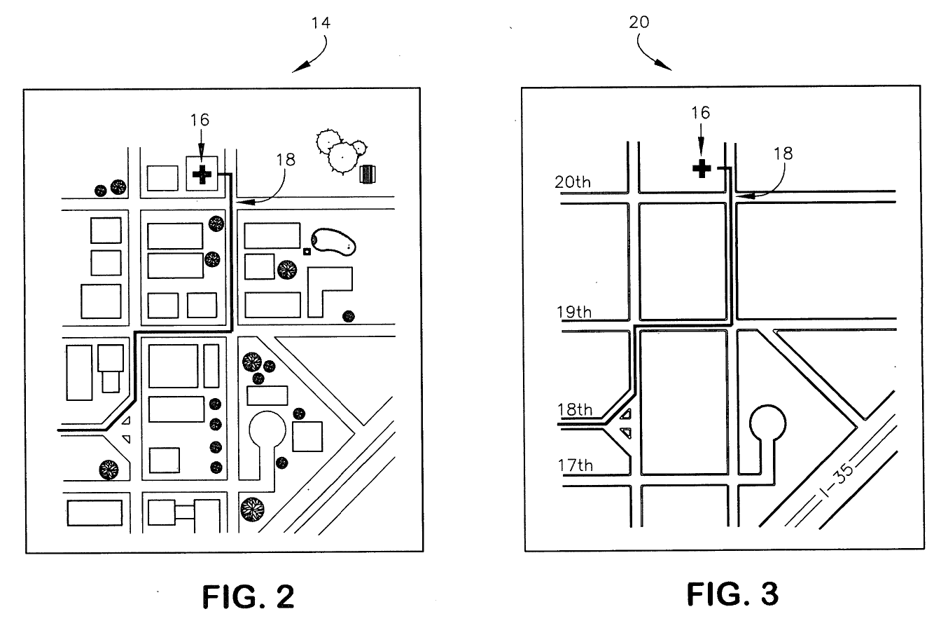

Also, referring to FIGS. 2 and 3, the present invention allows for toggling between different images while the aforementioned geo-referenced information remains continuously displayed (though possibly scaled, oriented, or otherwise appropriately adapted to the different images). Thus, for example, as shown in FIG. 2, a user might display a geo-referenced raster image of an aerial photograph 14 of his or her current location, and might display over the displayed aerial photograph 14 a waypoint 16 and the path 18 traveled to reach the user's current location (wherein such path is created by connecting determined periodic point locations), and, as shown in FIG. 3, might then toggle between the aerial photograph 14 and a corresponding street or topographical map 20 wherein the same waypoint 16 and path 18 remains displayed over the map 20. In this manner, the user can easily and quickly view or otherwise investigate prior paths, future paths, waypoints, and other geo-referenced information from a variety of perspectives. It is contemplated that such images, between which the user may toggle, may be automatically scaled and oriented relative to one another in order to eliminate disorientation and facilitate the user's quick and easy appreciation of the variety of perspectives.

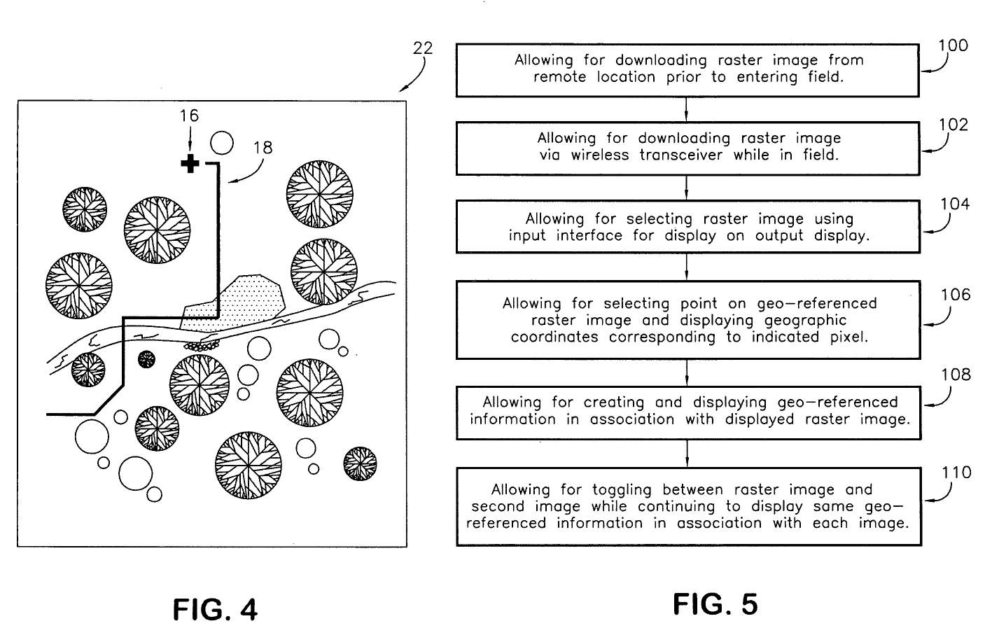

Referring also to FIG. 4, the geo-referenced raster image may be an aerial photograph 22 or other image of substantially any area, location, or type of terrain. For example, while FIG. 2 depicts an aerial photograph of an urban or residential area, FIG. 4 depicts an aerial photograph of a forested rural area which would be of greater interest to hunters or enthusiasts of other outdoor activities.

Referring again to FIG. 1, a preferred embodiment of the GPS device 10 broadly comprises a GPS unit 24; an input port 26 and/or a transceiver 28 and/or exchangeable memory devices 30, which shall be collectively referring to as obtainment mechanisms 32; an onboard memory 34; an input interface 36; an output display 38. It will be appreciated that devices using GPS technology for determining location are well-known to those with ordinary skill in the art, and therefore the present disclosure focuses primarily on the claimed features that comprise the present invention, rather than on said basic technology. The GPS device 10 as a whole is appropriately designed and constructed so as to be lightweight, rugged, waterproof, and otherwise resistant to relatively harsh environments and operating conditions.

The GPS unit 24 includes at least a processor 40, a receiver 42, and an antenna 44 for, in a conventional manner, receiving position signals from a plurality of known locations 46a,46b,46c,46d (e.g., from orbiting satellites) and, through a process of geometric triangulation, determining the relative location of the GPS unit 24.

The various obtainment mechanisms 32 provide alternatives whereby the raster images 12 can be obtained for subsequent display on the output display 38. In a first contemplated implementation, the input port 26 allows for prior downloading and storing of the raster images 12 from a remote source 50 via a network 52, such as an Internet, or other communication system. Thus, for example, the user might download and store one or more desired raster images 12 prior to entering the field. Alternatively, the input port 26 allows for prior downloading and storing the raster images 12 from a personal computer 54 which, in turn, downloaded and stored the raster images 12 from the remote source 50 via the network 52 or other communication system. Thus, for example, the user might download and store desired raster images 12 to the GPS device 10 via the personal computer 54 prior to entering the field, or, alternatively, might download and store desired raster images 12 using the personal computer 54 while in the field if the personal computer 54 includes or is connected to a transceiver for communicating wirelessly or otherwise with the remote source 50.

In a second contemplated embodiment, the transceiver 28 allows for prior or current downloading and storing of the desired images 12 via a wireless network or other communication system prior to entering or while in the field. The transceiver 28 may be fully integrated into the GPS device 10 or may be removably connected to the GPS device 10 via the aforementioned input port 26. It will be appreciated that the transceiver 28 provides the distinct advantage of allowing the user to, as desired, download and store raster images 12 in response to changing circumstances. Thus, for example, the user might, in response to ominous cloud formations or other apparent indicators of oncoming inclement weather, decide to download an aerial or Doppler radar image of local weather patterns.

In a third contemplated implementation, the exchangeable memory devices 30 allow for selecting and carrying a larger number of raster images than would otherwise be possible using only the GPS device's limited onboard memory 34. More specifically, a large number of raster images can be downloaded and stored on a plurality of the memory devices 30 prior to entering the field. When a particular image is desired, the particular one of the plurality of memory devices 30 on which the desired image is stored can be inserted or otherwise operatively connected with the GPS device 10 in order to access the desired raster image. When a different image is desired, the currently connected memory device is disconnected and the particular one of the plurality of memory devices 10 on which the desired different image is stored is inserted or otherwise connected. The memory devices 10 may take any appropriate form and use any available technology for information storage such as, for example, cartridges or disks with magnetic media, or disks with laser-readable media.

The onboard memory 34 is a fully-integrated memory device, such as conventional random access memory (RAM), that provides limited onboard storage capacity for storing downloaded raster images 12.

The input interface 36 allows the user to enter information when prompted or otherwise as appropriate, including indicating desired raster images to display. As such, the input interface 36 may take any appropriate form and use any available input technology such as, for example, keypad, touch-screen, or scroll-wheel technologies.

The output display 38 allows the GPS device 10 to communicate with the user, including presenting selections and/or prompting the user to make a selection, and to display the raster images. As such, the output display 38 may take any appropriate form and use any available technology such as, for example, liquid crystal display (LCD) technology.

Referring to FIG. 5, in contemplated exemplary but non-limiting use and operation, the present invention may be characterized as functioning in accordance with the following steps. Depending on the particular obtainment mechanism 32 used, one or more desired raster images 12 may either be downloaded from the remote location 50, such as by using the personal computer 54 connected to the Internet 52, and stored in the onboard memory 34 or on the exchangeable memory device 30 prior to entering the field, as shown in box 100, or downloaded from the remote location 50 via the transceiver 34 as needed or desired while in the field, as shown in box 102.

When it is desired to view the perspective of a particular one of the raster images 12, that image is selected using the input interface 36 and caused to be displayed on the display 38, as shown in box 104. The image is preferably displayed being oriented and scaled appropriately and/or is orientable and scalable as desired.

Because the raster image is geo-referenced, the user may move a pointer or other virtual pointing device over the raster image to a particular point of interest and cause to be displayed geographic coordinates corresponding to the indicated image pixel, as shown in box 106.

The user may also create and display one or more waypoints 16, past or future trails 18, points of interest, and other geo-referenced information on the raster image 14, as shown in box 108. This ability allows the user to more quickly and easily orient him- or herself to the perspective of the raster image 14, and integrates the raster image 14 more fully and usefully into the information scheme.

The user may then toggle between the current raster image 14 and one or more complementary maps 20, photographs, or other images while continuing to display the same geo-referenced information 16,18 over each such image 14,20, as shown in box 110. This ability eliminates disorientation while allowing the user to benefit from a variety of perspectives which are clearly related by the continuously displayed geo-referenced information 16,18.

From the preceding discussion it will be appreciated that the GPS device and method of the present invention provides a number of substantial advantages over the prior art, including, for example, allowing for displaying any of a variety of different types of geo-referenced raster images on a small, lightweight, and rugged GPS device, and for integrating said images into a scheme of information which is relevant to navigation and travel generally.

Furthermore, the present invention advantageously allows for displaying geo-referenced information over or otherwise in association with a displayed raster image, and for continuously displaying said information while toggling between maps, photographs, to other images or views, thereby eliminating disorientation and more fully and usefully integrating the raster image into the information scheme.

Although the invention has been described with reference to the preferred embodiments illustrated in the attached drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A GPS device for obtaining and displaying a raster image, the GPS device comprising:
a GPS unit including a receiver and an antenna for receiving signals from each of a plurality of sources and, based on the received signals, determining the geographic location of the GPS device;
an obtainment mechanism for obtaining the raster image so that it may be displayed on the GPS device;
an input interface for allowing a user to enter input for controlling the display of the raster image; and
an output display for displaying the raster image.

2. The GPS device as set forth in claim 1, wherein the raster image is selected from the group consisting of: aerial photographs, perspective photographs, topographical maps, satellite images, weather images, and Doppler radar images.

3. The GPS device as set forth in claim 1, wherein the raster image is created by capturing an emission of energy selected from the group consisting of: radio, visual, infrared, ultraviolet, electromagnetic, thermal, and sound.

4. The GPS device as set forth in claim 1, wherein the raster image is created by capturing a reflection of energy selected from the group consisting of: radio, visual, infrared, ultraviolet, electromagnetic, thermal, and sound.

5. The GPS device as set forth in claim 1, wherein the raster image is geo-referenced.

6. The GPS device as set forth in claim 5, wherein the raster image is geo-referenced by associating geographic location coordinates with each pixel of the raster image.

7. The GPS device as set forth in claim 1, wherein the input interface and output display allow for displaying geo-referenced information in association with the raster image.

8. The GPS device as set forth in claim 7, wherein the geo-referenced information is selected from the group consisting of: waypoints, trails, paths, and symbols.

9. The GPS device as set forth in claim 7, wherein the geo-referenced information is overlaid over the displayed raster image.

10. The GPS device as set forth in claim 7, wherein the input interface and the output display allow for toggling between the raster image and a second image, wherein the geo-referenced information remains continuously displayed for both the raster image and the second image.

11. The GPS device as set forth in claim 10, wherein the raster image and the second image are automatically similarly scaled and oriented when displayed.

12. The GPS device as set forth in claim 1, wherein the obtainment mechanism includes an input port for receiving the raster image from a remote source via a network.

13. The GPS device as set forth in claim 1, wherein the obtainment mechanism includes a transceiver for receiving the raster image from a remote source via a wireless connection.

14. The GPS device as set forth in claim 1, wherein the obtainment mechanism includes a plurality of exchangeable memory devices, with each of the exchangeable memory devices being capable of storing a plurality of raster images and of being removably coupled with the GPS device.

15. A GPS device for obtaining and displaying a geo-referenced raster image of an aerial photograph, the GPS device comprising:
a GPS unit including a receiver and an antenna for receiving signals from each of a plurality of sources and, based on the received signals, determining the geographic location of the GPS device;
an obtainment mechanism for obtaining the raster image of the aerial photograph so that it may be displayed on the GPS device, wherein the obtainment mechanism includes a transceiver for receiving the raster image from a remote source via a wireless connection;
an input interface for allowing a user to enter input for controlling display of the raster image of the aerial photograph and allowing for displaying geo-referenced information over the raster image of the aerial photograph; and
an output display for displaying the raster image of the aerial photograph and the geo-referenced information,
wherein the raster image is geo-referenced prior to display by associating geographic location coordinates with each pixel of the raster image.

16. The GPS device as set forth in claim 15, wherein the raster image is selected from the group consisting of: aerial photographs, perspective photographs, topographical maps, satellite images, weather images, and Doppler radar images.

17. The GPS device as set forth in claim 15, wherein the raster image is created by capturing an emission of energy selected from the group consisting of: radio, visual, infrared, ultraviolet, electromagnetic, thermal, and sound.

18. The GPS device as set forth in claim 15, wherein the raster image is created by capturing a reflection of energy selected from the group consisting of: radio, visual, infrared, ultraviolet, electromagnetic, thermal, and sound.

19. The GPS device as set forth in claim 15, wherein the geo-referenced information is selected from the group consisting of waypoints, trails, paths, and symbols.

20. The GPS device as set forth in claim 15, wherein the input interface and the output display allow for toggling between the raster image and a second image and the geo-referenced information remains continuously displayed for both the raster image and the second image.

21. The GPS device as set forth in claim 20, wherein the raster image and the second image are automatically similarly scaled and oriented when displayed.
